(19) United States
(12) Patent Application Publication
(10) Pub. No.: US 2008/0253491 A1
(43) Pub. Date: Oct. 16, 2008

(54) Method and Apparatus for Reducing Jitter in Multi-Gigahertz Systems

(75) Inventors: David C. Keezer, Roswell, GA (US); Dany Minier, Granby (CA); Patrice Ducharme, Brossard (CA)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignees: GEORGIA TECH RESEARCH CORPORATION, Atlanta, GA (US); INTERNATIONAL BUSINESS MACHINES CORPORATION, Armonk, NY (US)

(21) Appl. No.: 11/734,838

(22) Filed: Apr. 13, 2007

(51) Int. Cl. H04L 7/00

(52) U.S. Cl. 375/371

(57) ABSTRACT

An apparatus for generating an output signal that is analogous to an first signal from a first signal source that exhibits a first jitter, so that the output signal exhibits less jitter than the first jitter includes at least one second signal source generates a second signal that is analogous to and phase locked with the first signal. The second signal exhibits a second jitter that is uncorrelated with the first jitter. A signal averaging device is responsive to the first signal and the second signal. The signal averaging device averages the first signal and the second signal with respect to at least one parameter and thereby generates the output signal.

### BACKGROUND OF THE INVENTION

1. Field of the Invention

The present invention relates to signal processing systems and, more specifically, to a system that reduces jitter.

2. Description of the Prior Art

Controlling jitter on a picosecond (or smaller) time scale has become one of the most difficult challenges for testing multi-gigahertz systems. Jitter is an abrupt and unwanted variation of a characteristic (such as amplitude) of a signal. In electronic systems operating at moderate frequencies (e.g., roughly 100 MHz) picosecond jitter tends to be a relatively minor concern, as it is often overshadowed by other sources of timing errors, which occur at the nanosecond time scale. However, in multi-gigahertz electronic instruments (such as automatic test equipment), great care must be taken to reduce all timing error sources to the picosecond scale. With enough effort (including extensive calibration methods), today's electronic instruments systems can substantially reduce many of the traditional sources of timing errors. However, current systems have great difficulty in reducing jitter.

Jitter is always present to some degree and cannot be entirely eliminated and it tends to increase as new features are added to a system. Random jitter (RJ) is particularly troublesome because it is “unbounded.” This means that there is a finite probability of error for any measurement. Since there is a relationship between bit error rate (BER) in instruments and the timing distance from the average transition point (measured in number of standard deviations, σ), the timing error (for a specified BER) can be bounded by guardbanding (allowing sufficient timing margin to accommodate the expected amount of jitter).

A typical requirement for multi-gigahertz systems is to support a BER of 10⁻¹² (one in a trillion). Sometimes, even tighter BER requirements are required. For BER=10⁻¹² we must allow for a timing error of about 14σ (clearly much more stringent than traditional 6σ limits). If for example σ=10 ps, then 14σ=140 ps. At 5 Gbps, guardbanding for this timing error uses 70% of the available bit period (or “Unit Interval,” UI). Allowing for a 70% UI timing guardband would greatly reduce yields, and in most cases render the product unprofitable. The whole problem becomes even worse when we try to test many parallel data channels that must all be aligned in time at an input/output interface. In some cases there may be hundreds of such signals. In the future, the electronics industry will demand even tighter timing requirements.

Therefore, at data rate of a few gigahertz the value for σ needs to be in the picosecond range (or smaller, if possible). In practice, achieving a σ of 1 ps in a complex multi-gigahertz electronic instrument has been extremely difficult. Once jitter is introduced within a system it is very hard to eliminate it. Therefore, jitter is usually tackled at its source by starting with a very clean (low-jitter) timing reference oscillator. The signal is then distributed as carefully as possible within the device, minimizing the additional jitter picked up by the signal before eventually reaching the interface. Thus, substantial engineering effort and instrumentation costs are usually required to achieve this level of picosecond jitter. Even using extremely clean components and shielding, a certain amount of jitter will still be present.

Therefore, there is a need for an apparatus and method to reduce the severity of jitter in high frequency electronic instruments.

### SUMMARY OF THE INVENTION

The disadvantages of the prior art are overcome by the present invention which, in one aspect, is an apparatus for generating an output signal that is analogous to an first signal from a first signal source that exhibits a first jitter, so that the output signal exhibits less jitter than the first jitter. At least one second signal source generates a second signal that is analogous to and phase locked with the first signal. The second signal exhibits a second jitter that is uncorrelated with the first jitter. A signal averaging device is responsive to the first signal and the second signal. The signal averaging device averages the first signal and the second signal with respect to at least one parameter and thereby generates the output signal.

In another aspect, the invention is a method of generating an output signal that is analogous to an first signal and that exhibits less jitter than the first signal. At least one second signal that is analogous to and phase locked with the first signal is generated so that the second signal exhibits jitter that is uncorrelated with jitter exhibited by the first signal. The first signal is averaged with the second signal, thereby generating the output signal so that the output signal exhibits jitter that corresponds to the jitter exhibited by the first signal averaged with the jitter exhibited by the second signal.

In yet another aspect, the invention is a method of generating a low jitter signal corresponding to an electronic signal generated by an electronic instrument, in which a plurality of copies of the electronic signal is generated with the electronic instrument. Each copy exhibits jitter that is uncorrelated with jitter exhibited by each other copy of the plurality of copies. The plurality of copies are voltage averaged, thereby generating the low jitter signal.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing two analogous signals exhibiting uncorrelated jitter being averaged together to generate an output signal.

FIG. 2 is a schematic diagram of an embodiment in which a plurality of signal sources generate analogous signals that are averaged together to generate an output signal.

FIG. 3 is a schematic diagram of an embodiment that employs two signal generators and a resistive averaging network.

FIG. 4 is a schematic diagram of an embodiment that averages eight signals.

FIG. 5 is a schematic diagram of an embodiment in which analogous signals are generated with a plurality of delay lines.

FIG. 6 is a schematic diagram of an embodiment in which analogous signals are generated with a plurality of delay lines of varying lengths.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

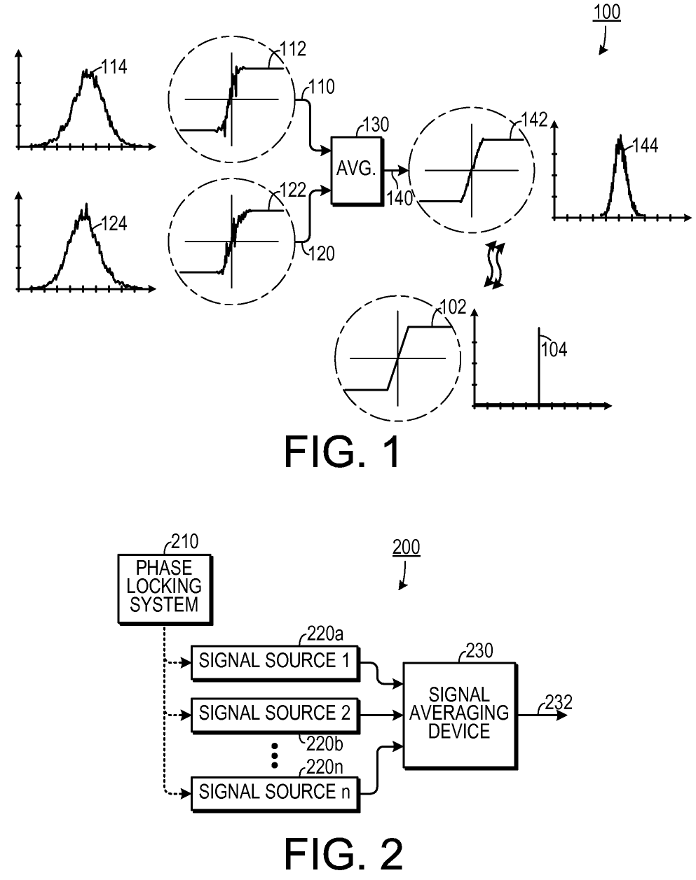

As shown in FIG. 1, in one embodiment of a system 100 for reducing jitter involves generating at least two analogous signals, such as a first signal 110 and a second signal 120, that are phase-locked with each other and that exhibit uncorrelated jitter. A graphical representation 102 of a transition of an ideal signal would have a corresponding jitter distribution histogram 104 that could be represented by a delta function. However, the actual first signal 110 would actually have a jittery signal trace 112 that has a nearly Gaussian jitter distribution histogram 114. Similarly, the second signal 120 would also have a jittery signal trace 122 that has a nearly Gaussian jitter distribution histogram 124. However, the jitter in the first signal 110 is uncorrelated with the jitter in the second signal 120.

The first signal 110 is averaged with the second signal 120 with an averaging device 130 that generates an output signal 140 that is an average of the first signal 110 and the second signal 120. The signal trace 142 corresponding to the output signal 140 exhibits less jitter, which has a narrower Gaussian distribution histogram 144 than the distribution histograms 114 and 124 corresponding to the first signal 110 and the second signal 120. Thus the jitter represented by the trace 142 of the output signal 140 more nearly approximates the ideal signal trace 102.

One embodiment of an apparatus 200 that minimizes jitter through averaging is shown in FIG. 2. A phase locking system 210, such as a common clock signal generator, sends a common driving or control signal to a plurality of signal sources 220a-n, such as a plurality of signal generators. Each of the signal sources 220a-n generates an analogous signal that is phase locked by the phase locking system 210. A signal averaging device 230 averages each of the analogous signals with respect to a selected parameter (e.g., voltage), resulting in an output signal 232 that exhibits less jitter than the signals from each of the signal sources 220a-n.

While several embodiments based on electronic systems are shown herein, the invention could readily apply to other types of systems. For example, the invention could be embodied in optical systems, acoustical systems and radio frequency electromagnetic systems. For example, in an optical system the parameter could be optical amplitude and the averaging of different signals could be accomplished through use of a combination of a beam combiner and an attenuator. It is intended that the scope of the claims below extends to all such embodiments.

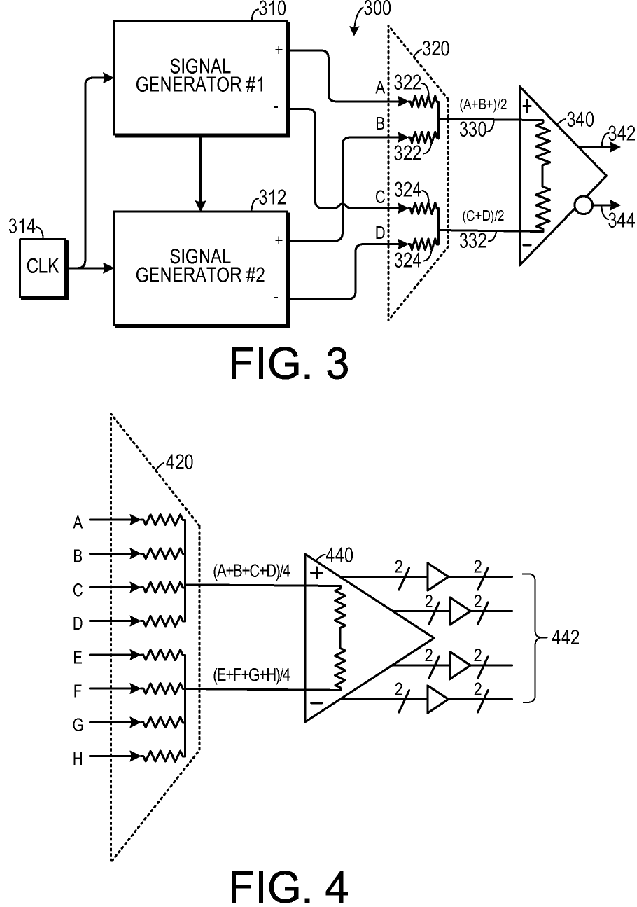

As shown in FIG. 3, a jitter reducing system 300 can be implemented with a first signal generator 310 and a second signal generator 312, both driven by a common clock 314. Typically, signal generators that operate in the gigahertz range generate both a signal and its complement. However, the method disclosed herein can be applied to single-ended signals (i.e., signals without compliments) and it is intended that the scope of the claims will extend at least to systems that employ both differential signals and single-ended signals. In such signal generators, a portion of the jitter in the signal is uncorrelated with the jitter in the compliment. Therefore, the copies of the signal (A and B) and the compliments (C and D) are averaged with a resistive voltage averaging device 320. The voltage averaging device 320 can include a first pair of resistors 322 that electrically couple the copies of the signal (A and B) to a first node 330 and a second pair of resistors 324 that electrically couple the copies of the compliments (C and D) to a second node 332. The signals from the first node 330 and the second node 332 are then fed into a differential logic buffer 340 that generates an output signal 342 and its complement 344, each corresponding to the signals generated by the signal generators 310. The resistive terminations within the differential logic buffer 340 serve to further average the non-correlated components of random jitter that may be present between nodes 330 and 332.

As shown in FIG. 4, increasing the number of analogous copies of the signal (A-H) that are averaged by the signal averaging network 420 can result an output signal 442 generated by the differential amplifier 440 that exhibits still less jitter than any one of the signals by itself.

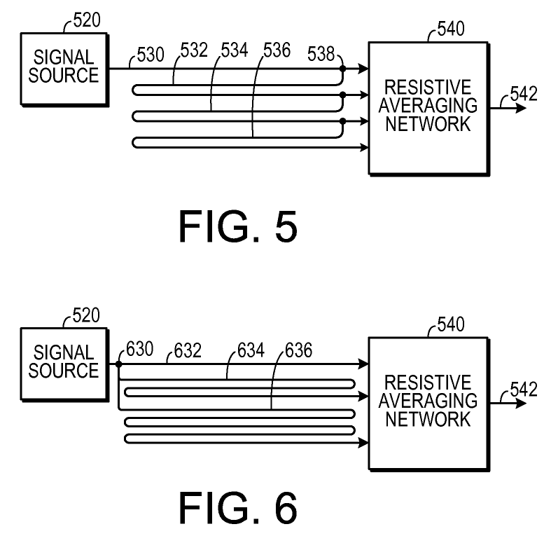

Rather that generating the analogous signals using active components, in one embodiment the analogous signals are generated, as shown in FIG. 5, using a plurality of delay lines. A signal source 520 generates a signal 530 and a first delay line 532, such as an electrical conductor, taps a copy of the signal 530 from an intermediate node 538 that is coupled to the signal 530. The first delay line 532 has a electrical length that is an integer multiple of the signal 530. Similarly, a second delay line 534 and a third delay line 536 can add additional delays. All of the subsequent signals that result from the delay lines are then averaged with a voltage averaging device 540, which generates the output signal 542.

Another delay line embodiment is shown in FIG. 6, in which three different signal paths 632, 634 and 636, each having different electrical lengths, each receive a signal from the signal source 520 at a common node 630. The resulting signals are then averaged with a voltage averaging device 540 as described above with reference to FIG. 5. In the delay line embodiments, if the signal is a periodic signal that is repetitive, such as a clock signal, then each delay line introduces a delay that is an integer multiple of the signal period.

### Experimental Embodiment

One experimental embodiment and supporting theory is now disclosed. Because testing at multi-gigahertz frequencies is so dependent on high-accuracy timing signals, it may be necessary to utilize more automated test equipment (“ATE”) resources for the most critical signals (such as clocks and timing references). In one experimental embodiment, multiplexing and demultiplexing modules were added to loadboards to synthesize multi-gigahertz test patterns using multiple 1 Gbps ATE channels.

Several “Driver” and “Receiver” modules were used to provide over 80 multi-Gbps differential channels in a combination of HyperTransport (1.6 Gbps per channel) and PCI-express (at 2.5 Gbps per channel). The ATE jitter level was typically in the range of 4 ps-8 ps, which is not sufficiently low for our testing needs in the 3 to 10 Gbps range. Therefore, a low-jitter (˜1.4 ps) RF clock source was used to provide a programmable timing reference to each of the modules. This level of jitter is a factor of 3 to 6 smaller than that produced by the ATE and meets the needs for testing in the 1 to 5 Gbps range (testing at 10 Gbps may require even better performance).

The external reference signal was used for various purposes by the different modules. In each case, this reference signal limits the timing accuracy that can be obtained by the module. While the external source provides a low-jitter timing reference, it has some practical drawbacks for the production test environment where external instruments are awkward. It is also difficult (but not impossible) to obtain precise synchronization (and skew adjustment) between the ATE and the external signal generator across a wide range of frequencies. Therefore, it would be preferable to obtain the timing reference signals directly from the ATE, if jitter could be reduced to acceptable levels (i.e., roughly 1 ps or less).

Five water-cooled receiver modules were mounted on the left side of the load-board, and five driver modules were on the right side. During production testing this entire assembly was flipped over and connected to the ATE test-head.

Theoretical Basis for Jitter Reduction:

It is commonly thought that once jitter is introduced into a system, it cannot subsequently be eliminated or reduced. However, under certain conditions it is possible to make a trade-off between the level of jitter and the amount of ATE hardware resources used to produce the signals. Existing ATE resources may be leveraged to produce the low-jitter timing reference signals. The method is generally applicable whenever low-jitter signals are required.

First consider a well-known effect that is observable on most digital sampling oscilloscopes (DSO). If we observe any repetitive signal at a fine enough timing scale we typically see either a “jittery” transition or (when selecting a longer persistence display mode) a wide transition band. The width of this jittery distribution band provides a crude estimate of total jitter (TJ). On the other hand, a common “trick” is to set the oscilloscope display to an “averaging” mode. Usually this will result in a much “nicer” display (narrower trace width on the screen) and generally make it easier to get repeatable timing measurements. It is deceptive that the much of the jitter seems to “disappear.” The signal is still jittery, it is just that the random components of this jitter are, in a sense “averaged out” by the sampling display process. What we are seeing on the screen is the result of many measurements taken over a long period of time. So we cannot use this effect directly to produce a useful real-time low-jitter signal.

If we analyze what is happening in the DSO, we see that the apparent jitter reduction occurs because the instrument is averaging widely-separated repetitions of the “same” signal. However, each repetition is not really the “same” signal, but rather another re-run of the test. Each time the scope is triggered (usually at a much slower rate than the data rate), the waveform is sampled at a completely different point in time (a different bit period). By synchronizing the scope trigger to a multiple of the bit period, it appears as though we are sampling the “same” signal.

So, how can this effect be used to generate a truly real-time averaging effect? If instead of serially averaging a repetitive signal, we average two or more parallel (synchronized) signals instead, then we can obtain the desired real-time effect. An ATE with many channels can provide these parallel signals. We can use a simple resistive network to combine and average (in real time) these signals (see below).

In one experimental embodiment, two synchronized signals (perhaps timing references or clocks from the ATE) are input to a simple resistive averaging network. The network is designed using standard impedance-matching techniques and resistive-divider configurations to produce an output which is proportional to the voltage average of the two input signals. A fast logic buffer is used to recover the full amplitude swing.

Several assumptions may be used to simplify the analysis and to quantify the effect: (1) The inputs are roughly synchronized (average transitions are synchronized, i.e., phase locked); (2) Each input signal has independent random characteristics (i.e., not correlated); (3) The resistive averaging network produces the instantaneous voltage-average of the two input signals; (4) The inputs signals have finite rise-times that are comparable to or longer than the total jitter (TJ); (5) The input signal edges are approximately linear near the 50% crossing point; (6) The logic buffer has an effective input threshold near to the 50% crossing point of the inputs; (7) For mathematical simplicity it will be assumed that RJ is similar for all the inputs (not strictly required); (8) For simplicity we neglect the fixed finite delay of the buffer and we assume that the jitter distribution of each signal is “normal” (Gaussian). In assumption (1) it is recognized the situation present in most ATE, where the entire system is usually driven with a common master clock. Assumption (2) is critical to the mathematical analysis which follows, and is the primary reason why the method is successful at reducing jitter. Basically the method relies on the independent random jitter of one signal to “average-out” part of the jitter in another input. Actually if the ATE signals were perfectly synchronized, then there would be no opportunity to exploit this effect. If both inputs were perfectly synchronized (with correlated jitter), then the resulting output jitter distribution would be exactly the same as that of the individual inputs (no improvement). In practice it was found that the assumption of independent random jitter seems to be valid for the ATE channels that were used in the experiments. Note that the effects of assumptions 3,4,5,6 together results in the circuit acting not only as a voltage-averager but also as a time-averager of the input transitions. This relationship simplifies the mathematical analysis that follows.

Given the assumptions described above, we can start the mathematical analysis by writing the probability density functions P_{A}(t_{A}) and P_{B}(t_{B}) for the two input signals based on the well-know Gaussian function, with their means set at t=0:

P_{A}(t_{A})=(1/σ_{A}√2π)exp(−(t_{A})²/2σ_{A}²)

P_{B}(t_{B})=(1/σ_{B}√2π)exp(−(t_{B})²/2σ_{B}²)

Where t_{A} and t_{B} are the 50% crossing times, and σ_{A} and σ_{B} are the standard deviations for the jitter distributions of inputs A and B respectively.

We can further simplify the mathematics by assuming that the two standard deviations are equal (σ_{A}=σ_{B}=σ). Then we have:

P_{A}(t_{A})=(1/σ√2π)exp(−(t_{A})²/2σ²)

P_{B}(t_{B})=(1/σ√2π)exp(−(t_{B})²/2σ²)

Using the resistive averaging network, the output timing (t_{C}) is the average of the two input timing values t_{A} and t_{B}. So t_{C} is given by:

t_{C}=(t_{A}+t_{B})/2

The variance, σ_{C}² for the output waveform is defined as:

σ_{C}²=∫_{-∞}^{+∞}(C₀−t_{C})²P_{C}dt_{C}

Since we have assumed that the means are zero (i.e., A₀=B₀=0), we can conclude also that C₀=0. Therefore we have:

σ_{C}²=∫_{-∞}^{+∞}(t_{C})²P_{C}dt_{C}

We can substitute P_{C}=P_{A}P_{B} and t_{C}=(t_{A}+t_{B})/2 and integrate over the two independent variables (t_{A}, t_{B}). Then the output signal variance becomes:

σ_{C}²=∫_{-∞}^{+∞}∫_{-∞}^{+∞}[(t_{A}+t_{B})/2]²P_{A}P_{B}dt_{A}dt_{B}

=(1/4)∫_{-∞}^{+∞}(t_{A}²+2t_{A}t_{B}+t_{B}²)P_{A}P_{B}dt_{A}dt_{B}

=(¼)[∫_{-∞}^{+∞}(t_{A}²)P_{A}dt∫_{-∞}^{+∞}P_{B}dt

+∫_{-∞}^{+∞}(t_{B}²)P_{B}dt∫_{-∞}^{+∞}P_{A}dt]+(zero terms)

=(¼)[∫_{-∞}^{+∞}(t_{A}²)P_{A}dt+∫_{-∞}^{+∞}(t_{B}²)P_{B}dt] because ∫_{-∞}^{+∞}P_{A}dt=1

σ_{C}²=(¼)[σ_{A}²+σ_{B}²]

Therefore,

σ_{C}=(½)(σ_{A}²+σ_{B}²)^{1/2}=2^{-1/2}σ=0.707σ

(again assuming that σ_{A}=σ_{B}=σ)

This shows that the output jitter is reduced to about 71% of the input jitter values (for two inputs). It is possible to generalize this result for the case of multiple (N) inputs as follows:

σₒᵤₜₚᵤₜ=(1/N)[(σ₁²+σ₂²+σ₃²+ . . . +σ_{N}²)]^{1/2}=N^{-1/2}σ

(if all inputs have the same standard deviation).

Table I indicates some representative values for the theoretical jitter reduction factor, depending upon the number of inputs, and assuming that all have the same amount of random jitter.

### (N):

TABLE I
Theoretical jitter reduction values as a
function of the number of inputs

| N | σ_{Output} |
|---|---|
| 1 | 100% σ |
| 2 | 71% σ |
| 4 | 50% σ |
| 8 | 35% σ |
| 16 | 25% σ |

Therefore, a reduction of jitter by a factor of 2, 3, or perhaps 4 or more seems feasible. From a practical perspective, there will be a point of diminishing returns since each additional input uses expensive ATE resources (channel pin electronics). There is also a practical limitation due the fact that the circuit used to combine the inputs itself adds some amount of jitter. As the number of inputs increases, it is likely that this added jitter will also increase, and limit the effectiveness of the jitter-reduction circuit. Also, the assumption that all inputs are nominally synchronized means that considerable calibration effort is required to measure and adjust all the input delay values. Higher values of N will therefore use more tester hardware and require longer calibration times.

Two experimental circuits in which N=2, N=4, and N=8 were tried, resulting in surprisingly close agreement with the predicted jitter reduction values. Practical limitations may prevent significant improvements beyond N=8 or so.

Experimental Validation of Jitter Reduction:

To validate the predicted jitter reduction values described in the last section, an experimental circuit with 4 inputs that could be connected either to external instruments or to four channels of an ATE (an Agilent 93000, P-1000) was constructed. A very low-jitter (σ ˜100 femtoseconds) SiGe Bipolar buffer was used to recover the full logic swing (in this case about 400 mV) following the resistive averaging network. The circuit design was fabricated using standard multilayer printed circuit board technology with controlled-impedance traces. Surface-mounted microwave chip resistors were used for the averaging network. The series resistor value (Rs) of 20 Ohms was chosen in order to provide a 50-Ohm impedance match into each of the 4 input ports (A,B,C,D). This allows the circuit to be driven from either the 50-Ohm source impedance ATE pin electronics or by standard test instruments. The resistive averaging circuit produces voltages proportional to the pair-wise averages of (A,B) and (C,D). These are used as the differential inputs for the SiGe buffer.

To accomplish the desired effect, the signals input to A and B should be nearly identical, and approximately synchronized (except for their independent jitter characteristics). Signals input to C and D should be the complements of A and B, again with independent jitter.

In a first test configuration two Agilent 81133A signal generators are phase-locked using a 10 MHz reference signal. Each instrument then uses its own internal oscillators and timing generators to produce the programmed differential signals, which are then connected to the 4 inputs of jitter reducing device. An Agilent 33250A AWG is used to provide a ˜50 MHz white noise voltage source to the signal generators for injecting jitter. The 81133A instruments use the random input voltage source to modulate their output signal delays. By adjusting the amplitude of the voltage noise the amount of injected timing jitter was controlled.

Cable lengths were also adjusted and delay settings were programmed to obtain non-correlated random jitter between the two signal generator outputs. Because the differential pair from the generator comes from a common source, its two halves are expected to have highly-correlated jitter characteristics. Therefore, even though there were 4 physical input ports, there were really only 2 independent jitter distributions in this first measurement configuration (N=2 for this setup). For the initial jitter measurements a Tektronix TDS6154C (15 GHz real time oscilloscope with 8 GHz differential input amplifier) was used. This instrument has time interval error (TIE) and jitter histogram analysis capabilities.

Tables II and III (below) provide the initial experimental results, showing the measured input and output jitter values as well as the theoretical predicted values. Because the TIE method does not require a separate trigger input to the TDS6154C, the measured values in Table II are generally more accurate than those in Table III (based on the traditional histogram method). The histogram method (Table III) consistently produces larger than expected measurements, perhaps due in-part to its reliance on an external trigger. Considering the difficulties in making these small-value measurements, we believe that they demonstrate good agreement with those predicted by theory.

TABLE II
Measurement results for experimental system,
using the TIE method:

| σ_{AC} | σ_{BD} | σ_{Z(Measured)} | σ_{Z(Theory)} | σ_{Z(Measured-Theory)} |
|---|---|---|---|---|
| 3.8 ps | 1.5 ps | 2.3 ps | 2.04 ps | 0.26 ps |
| 7.6 ps | 7.6 ps | 5.2 ps | 5.37 ps | −0.17 ps |
| 14.0 ps | 14.0 ps | 9.3 ps | 9.89 ps | −0.59 ps |
| 21.0 ps | 21.0 ps | 15.3 ps | 14.85 ps | +0.45 ps |

TABLE III
Measurement results for experimental system, using the histogram

| σ_{AC} | σ_{BD} | σ_{Z(Measured)} | σ_{Z(Theory)} | σ_{Z(Measured-Theory)} |
|---|---|---|---|---|
| 9.8 ps | 9.8 ps | 7.7 ps | 6.93 ps | +0.77 ps |
| 12.5 ps | 12.5 ps | 9.8 ps | 8.84 ps | +0.96 ps |
| 18.0 ps | 18.0 ps | 14.0 ps | 12.7 ps | +1.30 ps |
| 23.0 ps | 23.0 ps | 19.0 ps | 16.3 ps | +2.70 ps |

method:

For the final demonstration of our original Clock Cleaner 1, the two Agilent signal sources were replaced with four ATE channels and measured both the input and output random components of jitter (RJ). The jitter values were consistently about 4.1 ps across all four inputs. In this test configuration there was not a convenient way to adjust the amount of random jitter for the input signals (this was fixed by the Agilent 93000 ATE). Because there were four independent signals (N=4), the expected jitter for the clock cleaner output was 50% of the input σ values. The measured output jitter value is 1.79 ps, which is within 0.26 ps of the predicted value of 2.05 ps. This clearly shows that jitter can be reduced substantially for even low-jitter ATE signals using this new method.

In another experimental embodiment, a system with 8 inputs was used. Some other features were added to further minimize the jitter characteristics. These features included improved (higher-bandwidth) coaxial connectors, use of low-loss high-frequency dielectric materials in the PCB construction, double-buffering of the output signals, and a 1:4 fanout output buffer (providing four synchronous differential output ports).

The TDSJIT3 statistical analysis tools provide an even more detailed and accurate measurement values indicating that the output peak-to-peak total jitter at BER=10⁻¹² was only about 20 ps. This was about ⅓ that of the inputs total jitter values (typically ˜59 ps). Test results found random jitter standard deviations of 3.6 to 3.9 ps for the 8 independent inputs, with an average input jitter value is about 3.74 ps. The measured output jitter is 1.27 ps, which is within 40 femtoseconds of the predicted value (σ_{Z(Theory)}=0.35×3.74=1.31 ps). The method gives a practical way to reduce random jitter (approaching 1 ps) in a source that is directly controlled by the ATE (using no external instruments).

This technique has wide applicability to many systems where low-jitter is required, including multi-gigahertz ATE (with picosecond jitter requirements). Several measurements were made on two experimental circuits which clearly demonstrated the feasibility of this method and showed very close agreement with theory. For an example ATE application, we demonstrated reduction of signal jitter by about 65% (from 3.74 ps to 1.27 ps) using an 8-input version of this jitter reduction method. In this case the jitter reduction agreed with theory to within 40 femtoseconds. In the ATE application the low-jitter signal has the additional advantage of being under the direct control of the ATE, so that both frequency and delay (phase) can easily be adjusted as needed for a particular test. The low-jitter signals are also inherently synchronized with the rest of the ATE without the need for phase-locking or external instruments.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An apparatus for generating an output signal that is analogous to an first signal from a first signal source that exhibits a first jitter, so that the output signal exhibits less jitter than the first jitter, comprising:
a. at least one second signal source that generates a second signal that is analogous to and phase locked with the first signal so that the second signal exhibits a second jitter that is uncorrelated with the first jitter; and
b. a signal averaging device, responsive to the first signal and the second signal, that averages the first signal and the second signal with respect to at least one parameter thereby generating the output signal.

2. The apparatus of claim 1, wherein the parameter comprises a voltage.

3. The apparatus of claim 1, wherein the first signal is generated by a signal generator and wherein the second signal source comprises an inverse signal generating circuit.

4. The apparatus of claim 3, wherein the signal averaging device comprises a differential logic buffer.

5. The apparatus of claim 1, wherein the second signal source comprises a signal generator that receives a parameter input that is indicative of a parameter of the first signal.

6. The apparatus of claim 5, further comprising a common clock circuit that is configured to generate the parameter input.

7. The apparatus of claim 1, wherein the second signal source device comprises a delay line that is tapped from the first signal and that adds a delay to the first signal, thereby generating the second signal.

8. The apparatus of claim 7, wherein the first signal is a repetitive signal and has a signal period associated therewith and wherein the delay line introduces a delay that is an integer multiple of the signal period.

9. The apparatus of claim 7, wherein the first signal comprises an electronic signal and wherein the delay line comprises a conductor.

10. The apparatus of claim 1, wherein both the first signal and the output signal comprise electronic signals and wherein the signal averaging device comprises a voltage averaging device.

11. The apparatus of claim 10, wherein the voltage averaging device comprises a resistive averaging network.

12. A method of generating an output signal that is analogous to a first signal and that exhibits less jitter than the first signal, comprising the actions of:
a. generating at least one second signal that is analogous to and phase locked with the first signal so that the second signal exhibits jitter that is uncorrelated with jitter exhibited by the first signal; and
b. averaging the first signal with the second signal, thereby generating the output signal so that the output signal exhibits jitter that corresponds to the jitter exhibited by the first signal averaged with the jitter exhibited by the second signal.

13. The method of claim 12, wherein the action of generating the first signal comprises the actions of:
a. coupling the first signal to an intermediate node; and
b. coupling at least one delay line to the intermediate node so that at least one second signal is carried by each delay line.

14. The method of claim 13, wherein the first signal is a repetitive signal and has a signal period associated therewith and wherein each delay line introduces a delay that is an integer multiple of the signal period.

15. The method of claim 13, wherein the first signal comprises an electronic signal and wherein the delay line comprises a conductor.

16. The method of claim 12, wherein the first signal comprises an electronic signal and wherein the averaging step comprises the action of coupling the first signal and the second signal to a resistive averaging network.

17. The method of claim 12, wherein the first signal comprises an electronic signal and wherein the averaging step comprises the action of coupling the first signal and the second signal to a differential logic buffer.

18. A method of generating a low jitter signal corresponding to an electronic signal generated by an electronic instrument, comprising the actions of:
a. generating a plurality of copies of the electronic signal with the electronic instrument, wherein each copy exhibits jitter that is uncorrelated with jitter exhibited by each other copy of the plurality of copies; and
b. voltage averaging the plurality of copies, thereby generating the low jitter signal.

19. The method of claim 18, wherein the action of voltage averaging comprises coupling each of the copies to a resistive averaging network.
